(19) United States
(12) Patent Application Publication
(10) Pub. No.: US 2015/0259564 A1
(43) Pub. Date: Sep. 17, 2015

(54) EPOXY RESIN COMPOSITIONS

(71) Applicants: Yue SHEN, Shanghai (CN); Yan WU, (US); Fu ZHAN, (US); Ray DRUMRIGHT, Midland, MI (US); Liang HONG, Shanghai (CN); Fengzhe SHI, Shanghai (CN)

(72) Inventors: Yue Shen, Shanghai (CN); Yan Wu, Shanghai (CN); Fu Zhan, Shanghai (CN); Ray E. Drumright, Midland, MI (US); Liang Hong, Shanghai (CN); Fengzhe Shi, Shanghai (CN)

(21) Appl. No.: 14/438,331

(22) PCT Filed: Nov. 16, 2012
(86) PCT No.: PCT/CN2012/084733

§ 371 Date: Apr. 24, 2015

(51) Int. Cl. C09D 163/00

(52) U.S. Cl. CPC C09D 163/00

(57) ABSTRACT

An epoxy resin composition including at least one epoxy resin having the Formula (I):

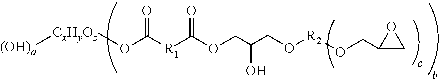

where a is an integer from 0 to 5, x is an integer from 3 to 15, y is an integer from 5 to 30, z is 0 or one, b is an integer from 3 to 10, c is an integer from one to 6, R₁ is a C₆ to C₂₀ cycloalkylene group, and R₂ is a saturated C₂ to C₂₀ aliphatic hydrocarbon group or a saturated C₅ to C₂₀ cycloaliphatic hydrocarbon group; a process for preparing the epoxy resin composition; and a curable coating composition comprising the epoxy resin composition.

### FIELD

The present invention relates to an epoxy resin composition. The present invention also relates to a curable coating composition comprising the epoxy resin composition.

### BACKGROUND

Epoxy resins are widely used in coating applications such as maintenance and protective coatings (M&PC). Multilayer coating systems generally comprise a topcoat and a primer coat, where the primer coat resides between a substrate being coated and the topcoat. Aromatic epoxy resins (for example, bisphenol-A epoxy resins) are widely used as primers, due to their satisfactory adhesion-to-metal strength and chemical resistance. However, coating films made from coating compositions based on aromatic epoxy resins suffer from chalking upon exposure to the elements such as sunlight. Thus, such aromatic epoxy resin-based coating compositions are not suitable for preparing topcoats, which require ultraviolet (UV)-resistance and weathering resistance (also known as weather durability or weatherability).

Currently, widely used topcoats are made from polyurethane (PU) coating compositions, since PU has better UV-resistance and weathering resistance than aromatic epoxy resins. However, compared to an epoxy topcoat, a PU topcoat can interact negatively with an epoxy primer coat, especially when applied at low temperature (for example, lower than 5 degree Celsius (° C.)) during the winter season. Such negative interactions may result in poor adhesion between a PU topcoat and an epoxy primer coat, even causing the PU topcoat to detach from the epoxy primer coat especially when coating application is during the winter.

Attempts have been made to increase weathering resistance of epoxy resins. For example, one approach is hydrogenation of aromatic rings in aromatic epoxy resins in the presence of a ruthenium-containing catalyst. Unfortunately, aromatic rings in the aromatic epoxy resins are difficult to completely hydrogenate. Thus, the resultant products may still contain residual unsaturation, resulting in unsatisfactory weathering resistance of topcoats. Moreover, epoxy resins suitable for producing topcoats need to have sufficient reactivity, so that a coating composition comprising the epoxy resins can be dried and cured quickly. For example, M&PC coatings typically require a tack-free time of less than 5 hours and a dry-hard time of within 24 hours at ambient temperature (that is, a temperature in a range from 21° C. to 25° C.), as determined by the test method described in ASTM D 5895. Additionally, flexibility and impact resistance are desirable properties for topcoats sufficient to enable the coating to maintain its integrity from deflection and/or bumping.

Therefore, it is desirable to provide an epoxy resin composition suitable for topcoat applications that is free from the challenges associated with aromatic epoxy resin compositions. It is also desirable to provide an epoxy resin coating composition, with the previously stated tack-free time and dry-hard time, that meets industrial requirements.

### BRIEF SUMMARY

The present invention offers solutions to prior art problems by providing an epoxy coating composition for producing a coating film therefrom having several advantages. For example, the coating film is free from the weathering problems associated with aromatic epoxy resin compositions. In addition, the curable coating composition has a tack-free time of less than 5 hours and a dry-hard time of within 24 hours at ambient temperature. Also, the coating composition allows for formation of a coating film having good flexibility (that is, having no cracking as measured by ASTM D 522). And, the coating film has an impact strength of at least 226.8 meter*grams (m*g) (50 centimeters*pound (cm*pound)) as measured by ASTM 2794 test. Moreover, the present invention solves the negative interaction problems between an epoxy primer and an incumbent PU topcoat made from a widely used high performance industrial PU coating composition as set forth in Comparative Example A, herein applied at a temperature of 5° C. or lower.

The present invention is a novel epoxy resin composition comprising at least one epoxy resin having the following Formula (I):

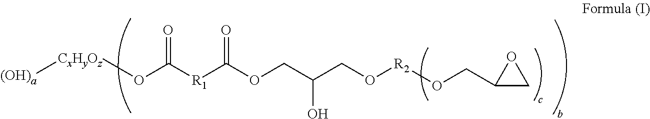

where a is an integer from 0 to 5, x is an integer from 3 to 15, y is an integer from 5 to 30, z is 0 or one, b is an integer from 3 to 10, c is an integer from one to 6, R₁ is a C₆ to C₂₀ cycloalkylene group, and R₂ is a saturated C₂ to C₂₀ aliphatic hydrocarbon group or a saturated C₅ to C₂₀ cycloaliphatic hydrocarbon group. The term “Cₜ” refers to a molecular fragment having t number of carbon atoms where t is a numeric value.

The novel epoxy resin composition of the present invention surprisingly provides a curable coating composition that achieves a tack-free time of 5 hours or less and a dry-hard time of 24 hours or less at ambient temperature, as determined by ASTM D 5895. At the same time, a coating film made from this curable coating composition shows satisfactory weathering resistance (that is, wherein the coating film exhibits a gloss loss of less than 30% after at least 400 hours of testing as determined by ASTM G154-6); and UV-resistance comparable to the incumbent PU topcoat set forth in Comparative Example A (“Incumbent PU Topcoat”). The curable coating composition of the present invention also provides a coating film with better adhesion to an epoxy primer coat than the Incumbent PU Topcoat when applied at 5° C. or lower. In addition, the coating film has no cracking as measured by ASTM D 522, and has an impact strength of at least 226.8 m*g (50 cm*pound) as measured by ASTM 2794.

In a first aspect, the present invention includes an epoxy resin composition, comprising at least one epoxy resin having the following Formula (I):

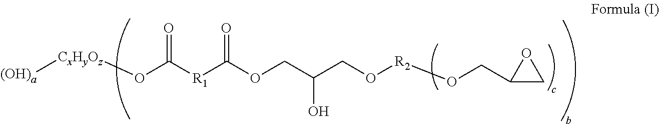

where a is an integer from 0 to 5, x is an integer from 3 to 15, y is an integer from 5 to 30, z is 0 or one, b is an integer from 3 to 10, c is an integer from one to 6, R₁ is a C₆ to C₂₀ cycloalkylene group, and R₂ is a saturated C₂ to C₂₀ aliphatic hydrocarbon group or a saturated C₅ to C₂₀ cycloaliphatic hydrocarbon group.

In a second aspect, the present invention includes a process of preparing the above epoxy resin composition of the first aspect; wherein the process comprises the steps of:

(i) providing a half-ester of a cycloaliphatic saturated carboxylic acid and/or its anhydride with an alcohol, wherein the alcohol is an alkyl alcohol or its dimer and has from 3 to 10 hydroxyl groups; and

(ii) reacting the half-ester with a saturated polyglycidyl ether of an alkyl alcohol and/or a saturated cycloaliphatic polyglycidyl ether to form the epoxy resin composition, wherein the molar ratio of the polyglycidyl ether to the carboxyl acid groups in the half-ester is 1 or higher.

In a third aspect, the present invention includes a curable coating composition comprising the epoxy resin composition of the first aspect, and an amine curing agent selected from an aliphatic amine or its adduct, a cycloaliphatic amine or its adduct, and mixtures thereof.

### DESCRIPTION

Test methods refer to the most recent test method as of the priority date of this document when a date is not indicated with the test method number. References to test methods contain both a reference to the testing society and the test method number. The following test method abbreviations and identifiers apply herein: ASTM refers to ASTM International. GB refers Guo Biao.

“And/or” means “and, or as an alternative”. All ranges include endpoints unless otherwise indicated.

### Epoxy Resin Composition

The epoxy resin composition of the present invention comprises at least one epoxy resin having the following Formula (I):

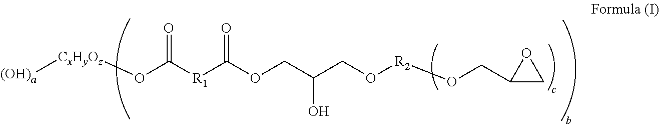

where a is an integer from 0 to 5, x is an integer from 3 to 15, y is an integer from 5 to 30, z is 0 or one, b is an integer from 3 to 10, c is an integer from one to 6, R₁ is a C₆ to C₂₀ cycloalkylene group, and R₂ is a saturated C₂ to C₂₀ aliphatic hydrocarbon group or a saturated C₅ to C₂₀ cycloaliphatic hydrocarbon group.

a can be 0, 1, 2, 3, 4, or 5, and preferably 0, 1, 2 or 3.

x is an integer of 3 or higher, preferably 4 or higher, and more preferably 5 or higher. At the same time, x is an integer of 15 or lower, preferably 12 or lower, and more preferably 10 or lower.

y is an integer of 5 or higher, preferably 6 or higher, and more preferably 8 or higher. At the same time, y is an integer of 30 or lower, preferably 24 or lower, and more preferably 20 or lower.

b is an integer of at least 3. If b is 2 or less, an epoxy resin composition having such structure could not achieve a tack-free time less than 5 hours and a dry-hard time within 24 hours at ambient temperature as determined by ASTM D 5895. At the same time, b may be an integer of 10 or less, preferably 6 or less, and more preferably 5 or less.

c can be 1 or higher, 2 or higher, or even 3 or higher. At the same time, c can be 6 or less, 5 or less, or even 4 or less.

R₁ is a C₆ to C₂₀ cycloalkylene group, that is, a saturated cycloaliphatic hydrocarbon group. “Hydrocarbon group” in the present invention refers a structure consisting only of hydrogen and carbon atoms. R₁ may be a cycloalkylene group substituted with one or more alkyl group, preferably a C₁-C₆ alkyl group. R₁ may be a divalent radical derived from a cyclic carboxylic acid or a cyclic carboxylic acid anhydride. R₁ may be a C₆ to C₂₀ cycloalkylene group having a structure of CₙH₂ₙ₋₂, wherein n is an integer of 6 or higher, and at the same time, 20 or lower, 10 or lower, or even 9 or lower. R₁ may be a group having the structure of

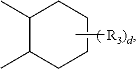

where R₃ is independently an alkyl group, preferably a C₁ to C₆ alkyl group, d is an integer from 0 to 4. R₁ is desirably a cyclohexene group or a methylcyclohexene group.

R₂ herein is a saturated C₂-C₂₀ aliphatic hydrocarbon group or a saturated C₅-C₂₀ cycloaliphatic hydrocarbon group. The cycloaliphatic group may comprise one or two cyclic rings, preferably at least one cyclohexane ring. R₂ may be derived from alkyl alcohols, or cycloaliphatic alcohols.

R₂ may be a saturated aliphatic group having a structure of CₘHₙ, wherein m is an integer of 2 or higher, and at the same time, 20 or lower, and preferably 8 or lower; n=2m+1-c, and c is as previously defined. R₂ may be a divalent group such as a linear or branched —C₂H₄—, —C₃H₆—, —C₄H₈—, —C₅H₁₀—, —C₆H₁₂—, —C₇H₁₄— or —C₈H₁₆— group, a trivalent group such as

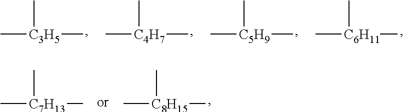

or a tetravalent group such as

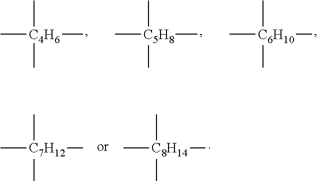

Examples of the R₂ group in the above Formula (I) may include a divalent group selected from propylene, 2-methylpropylene, neopentylene, 2-butyl-2-ethylpropylene, n-butylene group.

R₂ may be a saturated cycloaliphatic group having a structure of CₚH_{q}, where p is an integer from 5 to 20, q may be 2p-1-c if R₂ contains one cyclic ring, or 2p-3-c if R₂ contains two cyclic rings, and c is as previously defined.

When R₂ contains one cyclic ring, p is desirably 5 or higher, 6 or higher, and at the same time, p is desirably 15 or lower, preferably 10 or lower, and more preferably 9 or lower. When R₂ contains two cyclic rings, p is desirably 7 or higher, and at the same time, desirably 20 or lower, and preferably 15 or lower. R₂ may be a divalent group having the structure of

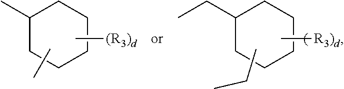

where R₃ and d are as previously defined. Preferably, R₂ is divalent group

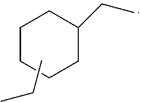

R₂ may be a trivalent group such as

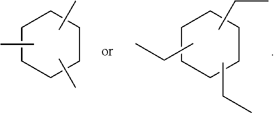

Examples of the R₂ group in Formula (I) above include a divalent group selected from 4,4′-(propane-2,2-diyl)dicyclohexyl, cyclohexylene, 1,2-cyclohexanedimethylene, 1,3-cyclohexanedimethylene or 1,4-cyclohexanedimethylene group.

One example of a desirable form of the epoxy resin of Formula (I) has the following structure:

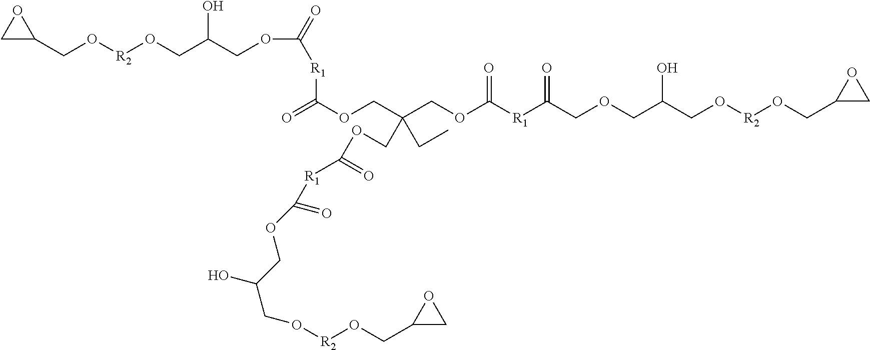

where R₁ and R₂ are as previously defined with reference to Formula (I). Preferably, R₁ is a group having the structure of

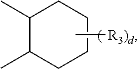

where R₃ and d are as previously defined. Preferably, R₂ is a group having the structure of

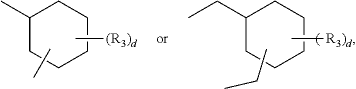

where R₃ is as previously defined, more preferably, R₂ is —(CH₂)₄—, or

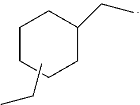

The epoxy resin composition of the present invention may be a mixture of different epoxy resins having the Formula (I). The epoxy resin composition may be a liquid mixture.

To further increase storage stability of the epoxy resin composition, the epoxy resin composition of the present invention desirably has an acid value of one milligram potassium hydroxide per gram sample (mg KOH/g) or less, preferably 0.5 mg KOH/g or less, and more preferably approximately zero. The acid value, that is, the number of milligrams of KOH per gram of solid required to neutralize the acid functionality in a resin, is a measure of the amount of acid functionality. Acid value may be determined by the testing method described in GB/T 2895-1982.

The epoxy resin composition of the present invention may have a viscosity of 10,000 millipascal.seconds (mPa·s) or higher, 15,000 mPa·s or higher, 20,000 mPa·s or higher, or even 30,000 mPa·s or higher. Viscosity of the epoxy resin composition may be measured by a Brookfield viscometer at 25° C. according to ASTM D 2393-1986.

The epoxy resin composition of the present invention desirably has an average epoxide equivalent weight (EEW) of about 400 or higher, about 450 or higher, or even about 500 or higher.

The epoxy resin composition of the present invention may comprise a reaction product of (a) one or more half-ester of a cycloaliphatic saturated carboxylic acid or its anhydride with an alcohol, wherein the alcohol can have from 3 to 10 hydroxyl groups and can be an alkyl alcohol, its dimer, or mixtures thereof, and (b) a saturated polyglycidyl ether of an alkyl alcohol or mixtures thereof, a saturated cycloaliphatic polyglycidyl ether or mixtures thereof, or blends of a saturated polyglycidyl ether of an alkyl alcohol and a saturated cycloaliphatic polyglyciyl ether, wherein the molar ratio of the polyglycidyl ether to the carboxyl acid groups in the half-ester is 1 or higher. The epoxy resin composition may comprise unreacted polyglycidyl ether from the above reaction. When present in the epoxy resin composition, the concentration of the unreacted polyglycidyl ether may be generally up to 40 weight percent or less, desirably 30 weight percent or less, preferably 20 weight percent or less, and more preferably 10 weight percent or less. Weight percentage of the unreacted saturated polyglycidyl ether is based on the total weight of the epoxy resin composition.

The epoxy resin composition of the present invention may optionally comprise an additional epoxy resin, the structure of which is different from Formula (I). The additional epoxy resin (or “second epoxy”) useful in the present invention may be any type of epoxy resins, including any material containing one or more reactive epoxy groups. The additional epoxy resin may include for example mono-functional epoxy resins, multi- or poly-functional epoxy resins, and combinations thereof. Generally, the additional epoxy resin, if present, may be used in an amount that can maintain the previously stated weathering resistance, UV-resistance and drying property. Preferably, the epoxy resin composition of the present invention is free from aromatic epoxy resins such as bisphenol-A epoxy resins which may compromise weathering-resistant and/or UV-resistant properties of the resultant coating composition. Examples of the additional epoxy resins may include the saturated polyglycidyl ether of an alkyl alcohol or the saturated cycloaliphatic polyglycidyl ether described above, any other aliphatic and cycloaliphatic epoxy resins known in the art, or combinations thereof. When present, the concentration of the additional epoxy resin (including the unreacted polyglycidyl ether in preparing the epoxy resin composition, if present) can be less than 40 weight percent, preferably less than 30 weight percent, and more preferably less than 10 weight percent. Weight percentage of the additional epoxy resin is based on the total weight of the epoxy resin composition. If the concentration of the additional epoxy resin is higher than 40 weight percent, the drying property of the resultant coating composition may be compromised.

### Preparation of Epoxy Resin Composition

The process of preparing the epoxy resin composition of the present invention comprises the following steps: (i) providing a half-ester of a cycloaliphatic saturated carboxylic acid, or its anhydride, with an alcohol, wherein the alcohol is an alkyl alcohol or its dimer, and wherein the alcohol has from 3 to 10 hydroxyl groups; and (ii) reacting the half-ester with a saturated polyglycidyl ether of an alkyl alcohol or a saturated cycloaliphatic polyglycidyl ether to form the epoxy resin composition, wherein the molar ratio of the polyglycidyl ether to the carboxyl acid groups in the half-ester is 1 or higher.

“Half-ester” herein refers to an ester compound containing a carboxylic acid group. The half-ester desirably has an ester group and a carboxylic acid group residing in ortho-position of a cyclic ring. The half-ester used to prepare the epoxy resin composition of the present invention may contain three or more carboxylic acid groups. The half-ester may comprise a mixture of two or more different half-esters. These half-ester mixtures may be prepared by using a mixture of two or more carboxylic acids, a mixture of two or more anhydrides and/or a mixture of two or more alcohols. The half-ester may be a mixture containing half-esters having different carboxylic acid functionalities, in particular, when alcohols having a high hydroxyl functionality (for example, 4 or more) are used to prepare the half-esters.

The half-esters used to prepare the epoxy resin composition of the present invention may have the following Formula (II):

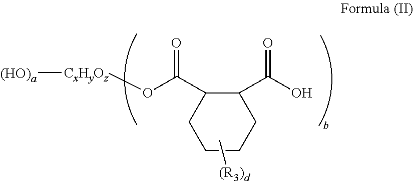

where a, x, y, z, b, R₃ and d in the above Formula (II) are as previously defined with reference to Formula (I).

The half-ester used to prepare the epoxy resin composition of the present invention may be prepared by reacting a cycloaliphatic saturated carboxylic acid or it anhydride with an alcohol. The alcohol used to prepare the half ester is an alkyl alcohol or a dimer of an alkyl alcohol, which has from 3 to 10 hydroxyl groups. The alkyl alcohol in the present invention refers to an alcohol only containing alkyl groups consisting of carbon and hydrogen atoms except hydroxyl groups. The alcohols can be primary, secondary or tertiary alcohols. The alcohols may comprise a mixture of two or more alcohols.

The number of hydroxyl groups (that is, the hydroxyl functionalities) in the alcohols can be 3 or more, 4 or more, or even 5 or more. At the same time, the hydroxyl groups in the alcohols can be 10 or less, desirably 8 or less, or even 6 or less. If an alkyl alcohol having two or less hydroxyl groups, or a polyether polyol is used, an epoxy composition obtained from such alkyl alcohol may show much longer tack-free time and dry-hard time than the epoxy resin composition of the present invention.

Preferably, the alcohols used to prepare the half-esters comprise at least one alkyl alcohol having 3 or more carbon atoms, preferably 4 or more, and more preferably 5 or more, carbon atoms. At the same time, the alcohols used to prepare the half-esters desirably comprise at least one alkyl alcohol having 15 or less, preferably 12 or less, and more preferably 10 or less, carbon atoms. The alcohols may be linear, branched, substituted, unsubstituted or cyclic ring-containing alkyl alcohols and/or their dimers.

The alkyl alcohols used to prepare the half-esters may have the following Formula (III):

CₓH_{(2x+2-b)}—(OH)_{b} Formula (III)

where x and b in the above Formula (III) are as previously defined with reference to Formula (I).

The alcohols used to prepare the half-esters may include triols, tetrols, pentols, hexols, heptols, their dimers, or mixtures thereof. Representative examples of suitable alcohols include glycerol; trimethylol propane (TMP); 1,1,1-tris-(hydroxymethyl)-propane; 1,1,1-trimethylolethane; hexane-1,2,6-triol; pentaerythritol, dipentaerythritol; arabitol; sorbitol; mannitol; volemitol; cyclohexane-1,2,3,4,5,6-hexol; or mixtures thereof. Preferably, the alcohols useful in the present invention are selected from glycerol, trimethylol propane, pentaerythritol, dipentaerythritol, diglycerol, or mixtures thereof.

The half-ester to prepare the epoxy resin composition of the present invention may be prepared by reacting the alcohols described above with a saturated cycloaliphatic carboxylic acid or its anhydride. A mixture of two or more saturated cycloaliphatic carboxylic acids or carboxylic anhydrides may be used. The saturated cycloaliphatic carboxylic acid anhydride is particularly useful in the present invention. More preferably, dicarboxylic acid anhydrides are used to prepare the half-ester.

Representative examples of anhydrides used to prepare the half-esters may include hexahydrophthalic anhydride, methylhexahydrophthalic anhydride, camphoric anhydride, cis-cyclopentanetetra carboxylic acid dianhydride, or mixtures thereof. Preferably, hexahydrophthalic anhydride, methylhexahydrophthalic anhydride, or mixtures thereof is used in the present invention.

Preparation of the half-ester can be conducted with conventional methods and conditions. For example, the half-ester may be prepared by mixing the alcohol with the anhydride and allowing the alcohol and the anhydride to react at a temperature range of from 50° C. to 220° C., preferably from 90° C. to 150° C. Reaction time for the alcohols and the anhydrides may vary depending on the factors such as the temperature employed, the chemical structure and/or the functionality of the alcohol used. For example, generally the reaction time may be from one to 5 hours, preferably from 2 to 4 hours.

The reaction of the alcohol with the anhydride may optionally include an esterification catalyst known in the art. The catalyst may include for example basic compounds such as 4-dimethylaminopyridine; Lewis acids; p-toluenesulfonic acid; protic acids; metal salts of the protic acids; quaternary phosphonium compounds; quaternary ammonium compounds; phosphonium; arsonium adducts or complexes with suitable nonnucleophilic acids such as fluoboric acids, fluoarsenic acids, fluoantimonic acids, fluophosphoric acids, perchloric acids, perbromic acids; periodic acids; or combinations thereof. When used, the catalyst may be mixed with the alcohol and the anhydride in any order.

In preparing the half-esters, the alcohols and the anhydrides are desirably mixed at a certain molar ratio, so as to achieve maximum conversion of the anhydride to the half-ester through the reaction of the anhydride group(s) in the anhydrides with hydroxyl groups in the alcohols. The degree of conversion of the anhydrides in the preparation of half-esters can be calculated in the usual manner from the difference between the theoretical acid value (that is, 50% of the acid value of the anhydride used) and the acid values of the half-ester obtained. The molar ratio of hydroxyl groups of the alcohol to anhydride group(s) of the anhydride is desirably 1.4 or less, preferably 1.3 or less, and more preferably 1.2 or less. At the same time, the molar ratio may be desirably 0.7 or more, preferably 0.9 or more, and more preferably 1.0 or more. If the molar ratio is higher than 1.4, unreacted alcohols may cause the reaction speed of the resultant half-esters with polyglycidyl ethers to proceed too fast to control.

In preparing the half-esters, hydroxyl groups in the alcohol may wholly or partially react with anhydride group(s) in the anhydride to form ester group(s). The half-ester obtained may be a mixture containing one half-ester having at least one unreacted hydroxyl group, in particular, when the alcohol used has a hydroxyl functionality of 4 or more.

To prepare the epoxy resin composition of the present invention, the half-esters described above further react with at least one saturated polyglycidyl ether of an alkyl alcohol, at least one saturated cycloaliphatic polyglycidyl ether, or combinations of at least one saturated polyglycidyl ether of an alkyl alcohol with at least one saturated cycloaliphatic polyglycidyl ether. Polyglycidyl ether herein refers to a multifunctional epoxy resin comprising more than one epoxy group (also known as “oxirane group” or “epoxy functionality” or “glycidyl ether”). The half ester can provide at least three carboxylic acid groups for reacting with at least one oxirane ring of the polyglycidyl ether to generate a second ester linkage in the epoxy resin composition obtained.

The polyglycidyl ether suitable for preparing the epoxy resin composition of the present invention has more than one epoxy group, for example, two or more epoxy groups, or even three or more epoxy groups. A mixture of two or more polyglycidyl ethers may be used.

The polyglycidyl ethers used to prepare the epoxy resin composition of the present invention may be polyglycidyl ethers of an alkyl alcohol. Mixtures of two or more polyglycidyl ethers of alkyl alcohols may be used in the present invention. These polyglycidyl ethers can generally be produced by etherification of the alkyl alcohols with epihalohydrins such as epichlorohydrin in the presence of alkali. Suitable alkyl alcohols used to prepare the polyglycidyl ethers may include alkyl alcohols (having 3 to 10 hydroxyl groups) used to prepare the half-esters described above, alkyl alcohols having 2 or less hydroxyl groups, or mixtures thereof.

The polyglycidyl ethers used to prepare the epoxy resin composition of the present invention may be saturated cycloaliphatic polyglycidyl ethers. Cycloaliphatic polyglycidyl ether herein refers to a resin having a glycidyl ether group residing on an aliphatic substituent of a ring structure and/or directly attached to the cycloaliphatic ring. Mixtures of two or more cycloaliphatic polyglycidyl ethers may be used in the present invention. Suitable cycloaliphatic polyglycidyl ethers include polyglycidyl ethers of alkyl alcohols having at least one alicyclic ring (for example, a cyclohexane ring or a cyclopentane ring). Preferably, a cyclohexanedialkanol diglycidyl ether is used to prepare the epoxy resin composition of the present invention,

Examples of suitable polyglycidyl ethers used to prepare the epoxy resin composition of the present invention may include 1,5-pentanediol diglycidyl ether; 1,2,6-hexanetriol diglycidyl ether; neopentane glycol diglycidyl ether; glycerol diglycidyl ether; 1,4-butanediol diglycidyl ether (BDDGE); 1,6-hexanediol diglycidyl ether (HDDGE); 2,2-bis(4-hydroxycyclohexyl)propane diglycidyl ether; 4,4′-(propane-2,2-diyl)dicyclohexyl diglycidyl ether; triglycidyl ether of glycerol; trimethylolpropane triglycidyl ether; tetraglycidyl ether of sorbitol; 1,4-cyclohexanedimethanol diglycidyl ether; 1,3 trans- or cis-cyclohexanedimethanol diglycidyl ether; 1,4 trans- or cis-cyclohexanedimethanol diglycidyl ether; a mixture comprising diglycidyl ether of cis-1,4-cyclohexanedimethanol and a diglycidyl ether of trans-1,4-cyclohexanedimethanol; a mixture of 1,3 and 1,4 cis- and trans-cyclohexanedimethanol diglycidyl ether; or mixtures of any of the above polyglycidyl ethers.

Preferably, the polyglycidyl ether used to prepare the epoxy resin composition of the present invention is selected from 1,6-hexanediol diglycidyl ether; 1,4-butanediol diglycidyl ether; trimethylolpropane triglycidyl ether; neopentane glycol diglycidyl ether; cyclohexanedimethanol diglycidyl ether; 4,4′-(propane-2,2-diyl)dicyclohexyl diglycidyl ether or mixtures thereof.

Preferably, the cycloaliphatic diglycidyl ether used to prepare the epoxy resin composition of the present invention is a cyclohexanedimethanol diglycidyl ether. The cyclohexanedimethanol diglycidyl ether can comprise a diglycidyl ether of cis-1,4-cyclohexanedimethanol, a diglycidyl ether of trans-1,4-cyclohexanedimethanol, or mixtures thereof. The cyclohexanedimethanol diglycidyl ether can comprise a product mixture comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, and a diglycidyl ether of trans-1,4-cyclohexanedimethanol. WO2009/142901, incorporated herein by reference, describes an epoxy resin composition comprising an example of a cycloaliphatic diglycidyl ether; a product mixture; and a method of isolating high purity diglycidyl ether (DGE) therefrom. Suitable cycloaliphatic polyglycidyl ethers also include those described in WO2012/044442A1, incorporated herein by reference.

In preparing the epoxy resin composition of the present invention, the half-ester and the polyglycidyl ether may be mixed together and reacted at a temperature of 90° C. or higher, and preferably 100° C. or higher. At the same time, the half-ester and the polyglycidyl ether may be mixed together and reacted at a temperature of 200° C. or lower, and preferably 150° C. or lower. If desired, the half-ester can first be dissolved in the polyglycidyl ether, optionally at an elevated temperature of for example, from 40° C. to 90° C.

In preparing the epoxy resin composition of the present invention, the reaction of the half-ester and the polyglycidyl ether can optionally and desirably be conducted in the presence of a catalyst to promote the reaction of the carboxylic acid groups in the half-ester with epoxy groups in the polyglycidyl ether. Examples of the optional catalysts used in the present invention include basic inorganic reagents, phosphines, quaternary ammonium compounds, phosphonium compounds or mixtures thereof. When the catalyst is used, the catalyst may be mixed with the half-ester and the polyglycidyl ether in any order. Preferably, after mixing the half-ester with the polyglycidyl ether, the catalyst can be added to the resultant mixture.

The reaction duration time of the half-ester and the polyglycidyl ether may be generally from 5 hours to 20 hours, and preferably 7 hours to 13 hours. The reaction time can be determined by testing the acid value of the epoxy resin composition obtained. The reaction can be stopped when the acid value of the resultant epoxy resin composition is one mg KOH/g or lower, preferably 0.5 mg KOH/g or lower, and more preferably zero.

In preparing the epoxy resin composition of the present invention, the molar ratio of the polyglycidyl ether resin to the carboxylic acid groups in the half-ester may be generally 1 or higher. The molar ratio herein refers to the ratio of the moles of the polyglycidyl ether (not the moles of epoxy groups) to the moles of the carboxylic acid groups in the half-ester. The molar ratio of the polyglycidyl ether to the carboxylic acid groups in the half-ester is desirably 5 or lower, preferably 3 or lower, more preferably 2 or lower, and most preferably 1.3 or lower. If the molar ratio of the polyglycidyl ether to the carboxylic acid groups in the half-ester is lower than 1, an epoxy resin composition obtained may tend to contain gel. If the molar ratio of the polyglycidyl ether to the carboxylic acid groups in the half-ester is higher than 5, unreacted polyglycidyl ether remaining in the epoxy resin composition obtained may have adverse effects on the drying property of the resultant coating composition.

The preparation of the epoxy resin composition may be free of, or in the presence of an organic solvent which may optionally be used in preparing the epoxy resin composition. The solvent, when present in the composition, can reduce the viscosity of the resultant products. When present, the organic solvent can be used in the preparing the half-ester and/or the reaction of the half-ester with the polyglycidyl ether described above and/or post added to the composition. Examples of suitable organic solvents include, for example, ketones, esters, aliphatic ethers, cyclic ethers, aliphatic, cycloaliphatic and aromatic hydrocarbons, or mixtures thereof. Preferred examples of the solvents include toluene, butyl acetate, pentane, hexane, octane, cyclohexane, methylcyclohexane, toluene, xylene, methylethylketone, methylisobutylketone, methylcyclohexane, cyclohexanone, cyclopentanone, diethyl ether, tetrahydrofuran, 1,4-dioxane, dichloromethane, chloroform, ethylene dichloride, methyl chloroform, tert-butyl ether, dimethyl ether, and mixtures thereof.

The solvent may be removed after completing the preparation of the half-ester and/or the reaction of the half-ester with the polyglycidyl ether described above using conventional means (for example, vacuum distillation). Alternatively, the solvent may also be left in the epoxy resin composition to provide a solvent borne epoxy resin composition which may be used later, for example, in the preparation of coating or film.

The epoxy resin composition can be cured using a curing agent (also referred to as a hardener or cross-linking agent) having an active group being reactive with an epoxy group of the epoxy resins. Examples of suitable curing agents useful in the present invention include anhydrides, nitrogen-containing compounds such as amines and their derivatives, oxygen-containing compounds, sulfur-containing compounds and mixtures thereof. In particular, aliphatic or cycloaliphatic curing agents are used to achieve optimum weathering resistance and/or UV-resistance.

Curing the epoxy resin composition of the present invention may be carried out, for example, at a temperature in a range from −10° C. up to about 300° C., preferably from −5° C. to 250° C., about 20° C. to about 220° C., and more preferably from about 21° C. to about 25° C.; and for a predetermined period of time which may be from minutes up to hours, depending on the curable epoxy resin composition, curing agent, and catalyst, if used. Generally, the time for curing or partially curing the epoxy resin composition may be from 2 seconds to 24 days, preferably from 0.5 hour to 7 days, and more preferably from one hour to 24 hours. It is also operable to partially cure the epoxy resin composition of the present invention and then complete the curing process at a later time. Advantageously, the epoxy resin composition can be cured by an amine curing agent at ambient temperature.

The epoxy resin composition of the present invention may be used in various applications, including for example, coatings, adhesives, electrical laminates, structural laminates, structural composites, filament windings, moldings, castings, encapsulations, pultrusion and any application where weathering resistance and/or UV-resistance is desirable.

### Curable Coating Composition

The curable coating composition of the present invention comprises the epoxy resin composition described above and an amine curing agent. The amine curing agent may comprise an aliphatic amine or its adduct, a cycloaliphatic amine or its adduct, or any combination thereof. The amines can be diamines, polyamines or mixtures thereof.

Examples of the amines useful in the present invention may include an aliphatic amine such as ethylenediamine (EDA); diethylenetriamine (DETA); triethylenetetramine (TETA); trimethyl hexane diamine (TMDA); tetraethylenepentamine; hexamethylenediamine (HMDA); 1,6-hexanediamine; N-(2-aminoethyl)-1,3-propanediamine; N,N′-1,2-ethanediylbis-1,3-propanediamine; dipropylenetriamine; cycloaliphatic amine such as isophorone diamine (IPDA); 4,4′-diaminodicyclohexylmethane (PACM); 1,2-diaminocyclohexane (DACH); 1,4-cyclohexanediamine; bis(aminomethyl)norbornane; heterocyclic amine such as piperazine, aminoethylpiperazine (AEP); polyether amine such as bis(aminopropyl)ether; polyamide; their adducts; and mixtures thereof. Preferred examples of amines useful in the present invention include aminoethylpiperazine (AEP) or its adduct; isophorone diamines (IPDA) or its adduct; diethylenetriamine (DETA) or its adduct; 4,4′-diaminodicyclohexylmethane (PACM) or its adduct; 1,2-diaminocyclohexane (DACH) or its adduct; polyether amine or its adduct; polyamide or its adduct; or combinations thereof.

The amine curing agent may comprise one or more adducts of the aliphatic and/or cycloaliphatic amines, for example, adducts of IPDA and BDDGE, adducts of IPDA and aliphatic acids, adducts of IPDA and CHDM epoxy resin, and mixtures thereof. The amine curing agent desirably comprises an adduct of the aliphatic and/or cycloaliphatic amine with the epoxy resin composition of the present invention. The amine curing agents may optionally comprise one or more accelerators and/or catalyst. Examples of the accelerators and catalysts include benzyl alcohol, 2,4,6-tris-(N,N-dimethyl-aminomethyl)-phenol, salicylic acid and mixtures thereof.

The amine curing agent may be used in a sufficient amount to cure the epoxy resin composition. A molar ratio of total epoxy functionality in the epoxy resins to total active hydrogen functionality of the amine curing agent in the curable coating composition may be generally 10:1 or lower, preferably 5:1 or lower, more preferably 4:1 or lower, and most preferably 2:1 or lower. At the same time, the molar ratio of total epoxy resins to the amine curing agent in the curable coating composition may be generally 1:2 or higher, preferably 1:1.5 or higher, more preferably 1:1.25 or higher, and most preferably 1:0.9 or higher.

The curable coating composition of the present invention can optionally contain inorganic extenders and/or pigments. The inorganic extenders and/or pigments may be ceramic materials, metallic materials including metalloid materials. Suitable ceramic materials include for example metal oxides such as zinc oxide, titanium dioxide, metal nitrides (for example, boron nitride), metal carbides, metal sulfides (for example, molybdenum disulfide, tantalum disulfide, tungsten disulfide, and zinc sulfide), metal silicates (for example, aluminum silicates and magnesium silicates such as vermiculite), metal borides, metal carbonates and mixtures thereof. These inorganic particles can be surface treated or untreated. When present in the curable coating composition, the inorganic extenders and/or pigments in the curable coating composition are generally from 5 weight percent to 60 weight percent, preferably 10 weight percent to 40 weight percent of the total weight of the curable coating composition.

In addition to the foregoing components, the curable coating compositions of the present invention can further comprise, or be free of, any one or combination of more than one of the following additives: anti-foaming agents, plasticizers, anti-oxidants, light stabilizers, UV-absorber, UV-blocking compounds, flow control agents, catalysts and accelerators. If present, these additives may be generally in an amount of 0.001 weight percent to 10 weight percent, and preferably 0.01 weight percent to 2 weight percent. Weight percentage of the additives is based on the total weight of the curable coating composition.

The components mentioned above present in the curable coating composition of the present invention may generally be dissolved or dispersed in an organic solvent. The optional organic solvent may be selected from the organic solvents described above; alcohols such as n-butanol, glycols such as ethylene glycol, propylene glycol, butyl glycol, glycol ethers such as propylene glycol monomethyl ether, ethylene glycol dimethyl ether; and mixtures thereof. The organic solvent is generally present in an amount of from 5 weight percent to 60 weight percent and preferably 8 weight percent to 20 weight percent. Weight percentage of the organic solvent is based on the total weight of the curable coating composition.

Preparation of the curable coating composition of the present invention is achieved by admixing the epoxy resin composition and the amine curing agent, preferably dissolved in the organic solvent. Other optional components including for example inorganic extenders and/or pigments and/or other optional additives may also be added, as described above.

Components in the curable coating composition may be mixed in any order to provide the curable coating composition of the present invention. Any of the above-mentioned optional components may also be added to the composition during the mixing or prior to the mixing to form the composition.

The curable coating composition of the present invention has a tack-free time of 5 hours or less and a dry-hard time of 24 hours or less at ambient temperature, as determined by ASTM D 5895.

The curable coating composition of the present invention can be applied by conventional means including brushing, dipping, rolling and spraying. The curable coating composition is preferably applied by spraying. The standard spray techniques and equipment for air spraying and electrostatic spraying, such as electrostatic bell application, and either manual or automatic methods can be used.

The curable coating composition of the present invention when deposited on a substrate forms a coating film. The curable coating composition can be applied to, and adhered to, various substrates. Examples of substrates over which the curable coating composition may be applied include wood, metals, plastic, foam, including elastomeric substrates, or substrates that are found on motor vehicles. The substrates typically contain a primer coat. Examples of the primers include epoxy primer and PU primer.

The curable coating composition of the present invention is suitable for various coating applications, such as marine coatings, protective coatings, automotive coatings, wood coatings, coil coatings and plastic coatings. The curable coating composition of the present invention is particularly suitable for topcoat applications.

Upon curing, the curable coating composition of the present invention forms a coating film. The coating film has better adhesion to an epoxy primer coat than the Incumbent PU Topcoat when applied at a temperature 5° C. or lower. In addition, an overcoating interval period of time between applying an epoxy primer and a topcoat composition is shorter than that of the Incumbent PU Topcoat, which can reduce waiting time and increase efficiency.

Upon curing, the curable coating composition of the present invention provides one or more the following properties:

(1) Satisfactory weathering resistance to achieve gloss loss less than 30% after at least 400 hours of testing as determined by ASTM G154-6. Preferably, the coating film achieves the gloss loss less than 30% after 500 hours or more testing, after 600 hours or more testing, after 700 hours or more testing, or even after 900 hours or more testing;

(2) Comparable UV-resistance to the Incumbent PU Topcoat;

(3) Higher adhesion to an epoxy primer coat than the Incumbent PU Topcoat when applied at 5° C. or lower;

(4) No cracking as measured by ASTM D 522;

(5) An impact strength of at least 226.8 m*g (50 cm*pound) as measured by ASTM 2794, preferably 362.9 m*g (80 cm*pound) or more, and more preferably 453.6 m*g (100 cm*pound) or more.

### EXAMPLES

The following examples illustrate embodiments of the present invention. All parts and percentages in the examples are by weight unless otherwise indicated. The following materials are used in the examples:

Methyl hexahydrophthalic anhydride (HMMPA) is available from Changzhou Bolin Chemical Company.

Trimethylolpropane (TMP) is available from Hubei Yihua Chemical Industry Co., Ltd.

1,4-Butanediol diglycidyl ether (BDDGE) is available from Anhui Hengyuan Chemical Co., Ltd.

Isophorone Diamine (IPDA) is available from BASF.

Diethylenetriamine (DETA) is available from The Dow Chemical Company.

Aminoethylpiperazine (AEP) is available from The Dow Chemical Company.

DOWANOL™ PM glycol ether is propylene glycol monomethyl ether (PGME), available from The Dow Chemical Company (DOWANOL is a trademark of The Dow Chemical Company).

Titanium dioxide (TiO₂) is available from DuPont.

n-Butyl acetate is available from The Dow Chemical Company.

Cyclohexanedimethanol diglycidyl ether (CHDM DGE) is prepared for use herein by the method described herein below.

Ethyltriphenylphosphonium iodide (ETPPI) is a quaternary phosphonium salt catalyst, commercially available from The Dow Chemical Company.

DESMOPHEN™ A 365 BA/X resin is a hydroxyl-bearing polyacrylate, commercially available from Bayer (DESMOPHEN is a trademark of Bayer Aktiengesellschaft Corporation).

Xylene is available from Shanghai First Reagent Co.

TINUYIN™ 292 light stabilizer is available from BASF (TINUVIN is a trademark of Ciba Specialty Chemicals Corporation).

DESMODUR™ N 75 polyisocyanate is an aliphatic polyisocyanate, available from Bayer (DESMODUR is a trademark of Bayer Aktiengesellschaft Joint Stock Company).

VORANOL™ CP260 polyol is a polypropylene glycol available from The Dow Chemical Company, that has a molecular weight of 255 Dalton and a functionality of 3 (VORANOL is a trademark of The Dow Chemical Company).

D.E.R.™ 736 resin is a diglycidyl ether of dipropylene glycol available from The Dow Chemical Company, that has an epoxide equivalent weight (EEW) of about 175-205 (D.E.R. is a trademark of The Dow Chemical Company).

D.E.R. 331 resin is a diglycidyl ether of bisphenol A, available from The Dow Chemical Company, that has an EEW of about 182-192.

UNOXOL™ Diol is a mixture cis-, trans-1,3- and 1,4-cyclohexanedimethanol, commercially available from The Dow Chemical Company (UNOXOL is a trademark of the Union Carbide Corporation).

The following standard analytical equipment and methods are used in the Examples.

### Measurement of Acid Value

The acid value is measured in accordance with GB/T 2895-1982. The acid value for a resin is defined as the mg KOH per gram of resin necessary to neutralize a resin in a simple titration using thymol blue as a color indicator. KOH is conveniently 0.1 N (mole per liter) in ethanol solution. The resin was dissolved in mixed solvents of toluene and ethanol (2:1 in volume).

### Drying Property

A BYK drying timer is used to record the tack-free time and dry-hard time of a coating composition according to ASTM D 5895. The coating composition to be evaluated is coated on the BYK drying timer for drying at ambient temperature.

### Adhesion Test

The adhesion between a primer coat and a topcoat is evaluated by cross hatch in accordance with ASTM D 3359.

73.5 weight parts of D.E.R. 331 resin are dissolved into 10 weight parts of xylene, then mixed with 16.5 weight parts of IPDA to form an epoxy primer composition. Weight parts are based on the total weight of the epoxy primer composition. After stirring for about 10 minutes, the epoxy primer composition is sprayed onto a blast-cleaned plate using an air spray method to form an epoxy primer coat on the plate. After one hour, an epoxy or PU top coating composition to be evaluated is sprayed onto the epoxy primer coat. After curing at 0° C. for 7 days or curing at 23° C. for 7 day, the adhesion between the epoxy primer coat and the topcoat is tested. The topcoat has an average thickness of 60 microns.

### QUV Test

73.5 weight parts of D.E.R. 331 resin are dissolved into 10 parts of xylene, then mixed with 16.5 weight parts of IPDA to form an epoxy primer composition. Weight parts are based on the total weight of the primer composition. After stirring for about 10 minutes, the epoxy primer composition is sprayed onto a blast-cleaned plate using an air spray method to form an epoxy primer coat on the plate. After one day, an epoxy or PU top coating composition to be evaluated is sprayed onto the epoxy primer coat, and cured at ambient temperature for 7 days to form a topcoat. Then, the plate is placed in a QUV Accelerated Weathering Tester (commercially available from The Q-Panel Company) outfitted with UVC bulbs, and exposed to ultra violet light, UVC with a wave length of 254 nm. The topcoat has an average thickness of 60 microns.

### Gloss

Gloss of coating films is measured according to ASTM D 523 using a BYK Micro-Tri-Gloss meter.

### Artificial Weathering Test

The artificial weathering test is conducted according to ASTM G154-6. The test includes the following repeating cycles: UV exposure at 60° C. for 4 hours, and condensation at 50° C. for 4 hours.

73.5 weight parts of D.E.R. 331 resin are dissolved into 10 weight parts of xylene, then mixed with 16.5 weight parts of IPDA to form an epoxy primer composition. Weight parts are based on the total weight of the epoxy primer composition. After stirring for about 10 minutes, the epoxy primer composition is sprayed onto a blast-cleaned plate using an air spray method to form an epoxy primer coat on the plate. After one day, an epoxy or PU top coating composition to be evaluated is sprayed onto the epoxy primer coat, then cured at ambient temperature for 7 days to form a topcoat for artificial weathering evaluation. The topcoat has an average thickness of 60 microns.

### Flexibility

Conical flexibility is conducted to evaluate the ability of a coating film to resist cracking in accordance with ASTM D 522. A coating composition to be evaluated is directly sprayed onto a tinplate to form a coating film. The coating film has an average thickness of 30 microns. If no cracking is observed on the film after testing, it indicates that the coating film has good flexibility.

### Impact Resistance

Impact resistance of a coating film is conducted in accordance with ASTM 2794. A coating composition to be evaluated is directly sprayed onto a tinplate to form a coating film. The coating film has an average thickness of 30 microns.

### Epoxide Equivalent Weight (EEW) Analysis

A standard titration method is used to determine percent epoxide in the various epoxy resins. The titration method used is similar to the method described in Jay, R.R., “Direct Titration of Epoxy Compounds and Aziridines”, Analytical Chemistry, 36, 3, 667-668 (March, 1964). In the present adaptation of this method, the carefully weighed sample (sample weight ranges from 0.17-0.25 gram (g)) was dissolved in dichloromethane (15 mL) followed by the addition of tetraethylammonium bromide solution in acetic acid (15 mL). The resultant solution treated with 3 drops of crystal violet indicator (0.1% wt/vol in acetic acid) was titrated with 0.1 N perchloric acid in acetic acid on a Metrohm 665 Dosimat titrator (Brinkmann). Titration of a blank consisting of dichloromethane (15 mL) and tetraethylammonium bromide solution in acetic acid (15 mL) provided correction for solvent background. Percent epoxide and EEW are calculated using the following equations:

$$\% Epoxide = \frac{[ ( mL titrated sample ) - ( mL titrated blank ) ] ( 0.4303 )}{( g sample titrated )}$$

$$E E W = \frac{43023}{\% epoxide}$$

### Preparation of Cyclohexanedimethanol Diglycidyl Ether (CHDM DGE)

### A. Epoxidation of 1,4-Cyclohexanedimethanol (CHDM)

A 5 liter (L), 4 neck, glass, round bottom reactor was charged with cis- and trans-1,4-CHDM (432.63 gram (g), 3.0 moles, 6.0 hydroxyl equivalent), epichlorohydrin (1110.24 g, 12.0 moles, 2:1 epichlorohydrin: cis- and trans-1,4-CHDM hydroxyl equivalent ratio), toluene (1.5 L), and 60% aqueous benzyltriethylammonium chloride (54.53 g, 32.72 g active, 0.1436 mole) in the indicated order. The reactor was additionally equipped with a condenser (maintained at 0° C.), a thermometer, a Claisen adaptor, an overhead nitrogen inlet (1 liter per minute (LPM) N₂ used), and a stirrer assembly (Teflon™ paddle, glass shaft, variable speed motor). Sodium hydroxide (360.0 g, 9.0 moles) dissolved in deionized (DI) water (360 g) was added dropwise to the reactor. The addition progressed for 250 minutes with reaction temperature of the reaction mixture held in range of 30 to 32.5° C. After 950 minutes of post reaction, the temperature in the reactor had declined to 26.5° C. DI water (1000 g) was added to the stirred reactor to dissolve precipitated salts. After 30 minutes stirring the biphasic mixture was separated. The water saturated organic phase recovered weighed 2565.14 g.

The organic layer was reloaded into the reactor along with fresh 60% aqueous benzyltriethylammonium chloride (27.26 g, 16.36 g active, 0.0718 mole). Sodium hydroxide (180 g, 4.5 moles) DI water (180 g) was added dropwise over 2 hours. After 958 minutes of post reaction, DI water (453 g) was added to the stirred reactor to dissolve precipitated salts. After 30 minutes stirring the biphasic mixture was separated. The water saturated organic phase recovered weighed 2446.24 g.

The organic layer was reloaded into the reactor along with fresh 60% aqueous benzyltriethylammonium chloride (13.64 g, 8.18 g active, 0.0359 mole). Sodium hydroxide (90 g, 2.25 moles) dissolved in DI water (90 g) was added dropwise over 100 minutes. After 980 minutes of post reaction, DI water (185 g) was added to the stirred reactor to dissolve precipitated salts. After 30 minutes stirring, the biphasic mixture was separated. The water saturated organic phase recovered weighed 2389.76 g. The organic layer was then washed twice with DI water (800 mL each time). The hazy organic solution was dried with anhydrous sodium sulfate. Volatiles were removed by rotary evaporation (bath temperature of 100° C.) to a final vacuum of 0.44 mm Hg. A total of 750.54 g of yellow colored, transparent 1,4-cyclohexanedimethanol liquid epoxy resin product was recovered after completion of the rotary evaporation. Gas chromatography (GC) analysis revealed the presence of 0.13 area % lights, 0.26 area % cis- and trans-1,4-CHDM, 3.85 area % monoglycidyl ethers (MGE), 0.23 area % of three minor components associated with the DGE peaks, 74.98 area % DGE, and 20.55 area % oligomers.

### B. Fractional Vacuum Distillation of CHDM Epoxy Resin

A portion of the product from the rotary evaporation was fractionally vacuum distilled to isolate the purified CHDM DGE. During the distillation, cuts were taken sequentially and analyzed by GC. DGE rich fractions were combined to give a sample that analyzed as 99.31 area % CHDM DGE by GC.

### Example 1

3.0 moles HMMPA and 1.0 mole TMP were charged into a reactor to form a mixture. The mixture was heated to 130° C. with stirring for about 3 hours. The mixture in the reactor was tested to determine its acid value intermittently at various time intervals. When the acid value of the mixture approached about 265 mg KOH/g, the reactor was cooled down to ambient temperature and a half-ester was obtained. 3.0 moles BDDGE was then charged into the reactor. After the half-ester was completely dissolved in BDDGE at 90° C., 300 ppm ETPPI was added. The reaction temperature was slowly raised to 110° C. and maintained at 110° C. for about 6 hours. When the acid value of the resultant compound approached 1 mg KOH/g or lower, the reaction was stopped. The resulting epoxy resin composition obtained from the above procedure has an average EEW of 540.

### Example 2

3.0 moles HMMPA and 1.0 mole TMP were charged into a reactor to form a mixture. The mixture in the reactor was heated to 130° C. with stirring for about 3 hours. The mixture was tested to determine its acid value intermittently at various time intervals. When the acid value of the mixture approached about 265 mg KOH/g, the reactor was cooled down and a hemi-ester was obtained. 3.0 moles CHDM DGE was then charged into the reactor. After the hemi-ester was completely dissolved in CHDM DGE at 90° C., 300 ppm ETPPI was added. The reaction temperature was heated to 110° C. and maintained at 110° C. for about 5 hours. When the acid value of the resultant compound approached 1 mg KOH/g or lower, the reaction was stopped. The resulting epoxy resin composition obtained from the above procedure has an average EEW of 500.

### Example 3

100 g of the epoxy resin composition of Example 1 was dissolved in 10 g of n-butanol and 20 g of propylene glycol monomethyl ether (PGME). 17 g of TiO₂ pigment was then dispersed into the epoxy resin composition to form Part A. Part B is a hardener formulation as shown below. Part B was mixed with Part A in a stoichiometric ratio of 1:1 to form a top coating composition of this Example 3.

| Part B | Weight parts* |
|---|---|
| IPDA | 11.5 |
| DETA | 15.9 |
| AEP | 4.8 |
| Epoxy resin composition of Example 1 | 26.4 |
| PGME | 26.4 |
| Isobutanol | 15.0 |

*Weight parts are based on the total weight of Part B.

### Example 4

100 g of the epoxy resin composition of Example 2 was dissolved in 10 g of n-butanol and 20 g of PGME. 17 g of TiO₂ pigment was then dispersed into the epoxy resin composition to form Part A. Part B is a hardener formulation, which is a blend of AEP and PGME at a weight ratio of 70:30. Part B was mixed into the Part A in a stoichiometric ratio of 1:1 to form a top coating composition of this Example 4.

### Comparative Example A

A two-pack PU coating composition shown below is widely used in M&PC market for producing a topcoat and can meet high performance topcoat standard. Part A and Part B were mixed, and stirred for about 30 minutes to form a PU top coating composition.

| PU coating composition | | Weight parts* |
|---|---|---|
| Part A | DESMOPHEN A 365 BA/X resin | 41.7 |
| | Xylene | 11.9 |
| | TiO₂ | 23.5 |
| | n-Butyl acetate | 7.0 |
| | TINUVIN 292 light stabilizer | 0.2 |
| Part B | DESMODUR N 75 aliphatic polyisocyanate | 15.8 |

*Weight parts are based on the total weight of the PU coating composition.

### Comparative Example B

23.62 g of HMMPA and 17.8 g of VORANOL CP260 polyol were charged into a reactor and heated to 130° C. After 3 hour at 130° C., the acid value reached about 190 mg KOH/g and a hemi-ester was obtained. 58.8 g of D.E.R. 736 resin was charged into the resultant hemi-ester. After the hemi-ester was completely dissolved in D.E.R. 736 resin at 90° C., 1500 ppm ETPPI was then added into the reactor, and the reaction temperature was slowly raised to 125° C. The reaction was stopped when the acid value of the resultant compound was below 1 mg KOH/g. The resulting epoxy resin composition obtained from the above procedure had an average EEW of about 590.

100 g of the epoxy resin composition obtained was dissolved into 12 g of n-Butyl acetate to form Part A. Part B was a hardener formulation, which was a blend of AEP and n-Butyl acetate at a weight ratio of 70/30. Part B was mixed into Part A in a stoichiometric ratio of 1:1 to form a coating composition of this Comparative Example B.

### Comparative Example C

2.0 moles HMMPA and 1.0 mole UNOXIOL Diol were charged into a reactor and heated to 130° C. The resultant mixture in the reactor was heated to 130° C. with stirring for about 3 hours. At time intervals, the reaction mixture was tested to determine the acid value of the reaction mixture. When the acid value approached about 190 mg KOH/g, the reactor was cooled down and a half-ester was obtained. 2.0 moles BDDGE was charged into the resulted half-ester. After the half-ester was completely dissolved in BDDGE at 90° C., 300 ppm ETPPI was added and the reaction temperature was slowly raised to 110° C. When the acid value reached below 1 mg KOH/g, the reaction was stopped. The resulting comparative epoxy resin composition obtained from the above procedure had an average EEW of about 560 g/eq.

100 g of the comparative epoxy resin composition obtained was dissolved in 12 g of n-Butyl acetate to form part A. Part B was a hardener formulation, which was a blend of AEP and n-Butyl acetate at a weight ratio of 70/30. Part B was mixed into Part A in a stoichiometric ratio of 1:1 to form a coating composition of this Comparative Example C.

Drying properties of the above coating compositions and properties of coating films formed from the coating compositions were evaluated according to the testing methods described above.

Table 1 shows drying properties of coating compositions of Examples 3 and 4, and of coating compositions of Comparative Examples B and C. The coating compositions of Examples 3 and 4 had a tack-free time of less than 5 hours and a dry-hard time of within 24 hours at ambient temperature. In contrast, the coating compositions of Comparative Examples B and C showed a much longer tack-free time and dry-hard time at ambient temperature than the inventive coating compositions. The coating compositions of Comparative Examples B and C could not meet industrial requirements of being tack-free in less than 5 hours and having a dry-hard time within 24 hours.

TABLE 1

| Coating Composition | Tack-Free Time | Dry-Hard Time |
|---|---|---|
| Example 3 | 2.4 hour | 14.5 hour |
| Example 4 | 1.5 hour | 6.5 hour |
| Comparative Example B | Sticky after 3 weeks | N/A |
| Comparative Example C | 7.5 hour | >24 hour |

Table 2 shows gloss levels and gloss retention of cured coatings after the QUV test. As described in Table 2, epoxy topcoats made from Example 3 and 4 showed initial gloss levels comparable to the PU topcoat made from Comparative Example A. After exposure for about 700 hours or more, the epoxy topcoats showed significantly higher gloss than that of the PU topcoat. After exposure for 750 hours, gloss retention for topcoats made from Example 3, Example 4 and Comparative Example A was 86.2%, 82.4% and 63.3%, respectively. After exposure for around 960 hours, gloss retention of the epoxy topcoat made from Example 3 was still around 78%, as compared to 52% gloss retention of the PU topcoat made from Comparative Example A. It indicates that the epoxy topcoats made from the coating compositions of the present invention have better UV-resistance than the PU topcoat made from Comparative Example A.

TABLE 2

| | | | | | Comparative | |
|---|---|---|---|---|---|---|
| | Example 3 | | Example 4 | | Example A | |
| Exposure | | Gloss | | Gloss | | Gloss |
| time | Gloss, | reten- | Gloss, | reten- | Gloss, | reten- |
| (hour) | degree | tion, % | degree | tion, % | degree | tion, % |
| 0 | 90.6 | 100 | 89.1 | 100 | 86.0 | 100 |
| 72 | 88.6 | 97.8 | — | — | 83.6 | 97.2 |
| 132 | 87.2 | 96.2 | 88.4 | 99.2 | 80.3 | 93.4 |
| 216 | 85.3 | 94.2 | — | — | 78.7 | 91.5 |
| 356 | 82.7 | 91.3 | 80.3 | 90.1 | 77.8 | 90.5 |
| 470 | 80.8 | 89.2 | 80.1 | 89.9 | 72.1 | 83.8 |
| 600 | 79.4 | 87.6 | 76.8 | 86.2 | 69.5 | 80.8 |
| 750 | 78.1 | 86.2 | 73.4 | 82.4 | 54.4 | 63.3 |
| 870 | 74.3 | 82.0 | — | — | 48.5 | 56.4 |
| 960 | 70.9 | 78.3 | — | — | 44.7 | 52.0 |

Table 3 shows gloss of the topcoat made from Example 4 during the artificial weathering test. The initial gloss of the topcoat was about 90 degree. After exposure for around 995 hours, the gloss loss of the topcoat was only about 22%. In particular, the topcoat made from Example 4 achieved the weathering resistance without the requirement of using UV stabilizers or UV absorbers.

TABLE 3

| | Gloss of epoxy topcoat |
|---|---|
| Exposure time (hour) | (degree) |
| 0 | 89.6 |
| 170 | 85.2 |
| 356 | 83.8 |
| 536 | 81.5 |
| 754 | 80.2 |
| 995 | 69.8 |

The cross-hatch adhesion between an epoxy primer coat and a topcoat was evaluated according to the Adhesion Test method described above. An overcoating interval period of time (that is, time period between applying an epoxy primer and a topcoat composition) was one hour for the adhesion test. In the coating industry, an epoxy primer is usually left overnight before applying a PU topcoat composition. The topcoat compositions were cured at two different conditions: 0° C. for 7 days, or 23° C. for 7 days.

The PU topcoats made from Comparative Example A cured at the two different conditions both showed 0B rating in the adhesion test. The PU topcoat cured at 0° C. for 7 days was easily peeled off from the epoxy primer coat by scraping. The PU topcoat cured at 23° C. for 7 days was easily peeled off by a sealing tape. In contrast, the epoxy topcoats made from Example 3 and 4 cured at two different conditions both showed 5B rating. No failure was observed for the epoxy topcoats when being peeled by a sealing tape. The results of the adhesion test shows that the epoxy topcoats made from the coating composition of the present invention has better adhesion to the epoxy primer coat than the PU topcoat made from Comparative Example A at 0° C. It also indicates that the coating compositions of the present invention can provide shorter overcoating interval period of time than that commonly applied in the industry, which can reduce waiting time and increase efficiency.

Moreover, coating films made from the coating compositions of Examples 3 and 4 had no cracking as determined by ASTM D 522, which indicates that the coating films have good flexibility. The coating films based on the coating compositions of Examples 3 and 4 also had an impact strength and a reverse impact strength both larger than 453.6 m*g (100 cm*pound).

1. An epoxy resin composition, comprising at least one epoxy resin having the Formula (I): 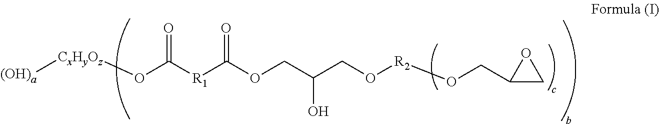
where a is an integer from 0 to 5, x is an integer from 3 to 15, y is an integer from 5 to 30, z is 0 or one, b is an integer from 3 to 10, c is an integer from one to 6, R₁ is a C₆ to C₂₀ cycloalkylene group, and R₂ is a saturated C₂ to C₂₀ aliphatic hydrocarbon group or a saturated C₅ to C₂₀ cycloaliphatic hydrocarbon group.

2. The epoxy resin composition of claim 1, wherein a is an integer from 0 to 3, x is an integer from 4 to 12, y is an integer from 5 to 24, b is an integer from 3 to 6, and c is an integer from one to 3.

3. The epoxy resin composition of claim 1, wherein R₁ is a C₆ to C₁₀ cycloalkylene group, and R₂ is a saturated C₂ to C₈ aliphatic hydrocarbon group or a saturated C₅ to C₁₅ cycloaliphatic hydrocarbon group.

4. The epoxy resin composition of claim 1, wherein R₂ is a group selected from a linear or branched —C₂H₄—, —C₃H₆—, —C₄H₈—, —C₅H₁₀—, —C₆H₁₂—, —C₇H₁₄— or —C₈H₁₆— group; cyclohexylene; 1,2-cyclohexanedimethylene; 1,3-cyclohexanedimethylene; 1,4-cyclohexanedimethylene; 4,4′-(propane-2,2-diyl)dicyclohexyl;

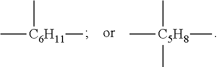

5. The epoxy resin composition of claim 1, wherein R₁ is a divalent group selected from a cyclohexene group and a methylcyclohexene group.

6. The epoxy resin composition of claim 1, wherein the epoxy resin composition has an acid value of one milligram potassium hydroxide per gram or less.

7. The epoxy resin composition of claim 1, wherein the epoxy resin composition is free from aromatic epoxy resins.

8. A process of preparing the epoxy resin composition of claim 1, wherein the process comprising the steps of:
(i) providing a half-ester of an aliphatic or cycloaliphatic saturated carboxylic acid or its anhydride with an alcohol, wherein the alcohol is an alkyl alcohol or its dimer and has from 3 to 10 hydroxyl groups; and
(ii) reacting the half-ester with a saturated polyglycidyl ether of an alkyl alcohol and/or a saturated cycloaliphatic polyglycidyl ether to form the epoxy resin composition, wherein the molar ratio of the polyglycidyl ether to the carboxyl acid groups in the half-ester is 1 or higher.

9. The process of claim 8, wherein the alcohol used to prepare the half ester is selected from glycerol, trimethylol propane, pentaerythritol, dipentaerythritol, diglycerol or mixtures thereof.

10. The process of claim 8, wherein the anhydride is selected from hexahydrophthalic anhydride, methylhexahydrophthalic anhydride, or mixtures thereof.

11. The process of claim 8, wherein the polyglycidyl ether is selected from 1,6-hexanediol diglycidyl ether; 1,4-butanediol diglycidyl ether; trimethylolpropane triglycidyl ether; neopentane glycol diglycidyl ether; cyclohexanedimethanol diglycidyl ether; 4,4′-(propane-2,2-diyl)dicyclohexyl diglycidyl ether or mixtures thereof.

12. The process of claim 8, wherein the half-ester is prepared by reacting the alcohol with the anhydride at a molar ratio of hydroxyl groups of the alcohol to anhydride group(s) of the anhydride ranging from 1.4:1 to 1:1.

13. The process of claim 8, wherein the molar ratio of the polyglycidyl ether to the carboxyl acid groups in the half-ester is in the range of 3:1 to 1:1.

14. The process of claim 8, wherein the half-ester reacts with the polyglycidyl ether in the presence of a catalyst selected from phosphines, quaternary ammonium compounds, phosphonium compounds or mixtures thereof.

15. A curable coating composition comprising the epoxy resin composition of claim 1, and an amine curing agent selected from an aliphatic amine or its adduct, a cycloaliphatic amine or its adduct, and mixtures thereof.

16. The curable coating composition of claim 15, wherein the amine curing agent is selected from aminoethylpiperazine; isophorone diamine;
diethylenetriamine;
4,4′-diaminodicyclohexylmethane; 1,2-diaminocyclohexane; polyether amine;
polyamide; and mixtures thereof.
